(19) United States
(12) Patent Application Publication
(10) Pub. No.: US 2003/0161211 A1
(43) Pub. Date: Aug. 28, 2003

(54) Control system and method for forming slurries

(76) Inventors: Alan B. Duell, Duncan, OK (US); Paul A. Brown, Duncan, OK (US); Perry A. Jones, Comanche, OK (US); Troy Bachman, Duncan, OK (US); Rodney E. McCauley, Comanche, OK (US); Joseph K. Maxson, Rawlins, WY (US)

Correspondence Address: JOHN W. WUSTENBERG, P.O. BOX 1431, 2600 SOUTH 2ND STREET, DUNCAN, OK, 73536, US

(21) Appl. No.: 10/085,443

(22) Filed: Feb. 28, 2002

(51) Int. Cl. B01D 3/12

(52) U.S. Cl. 366/8; 366/19; 366/29; 366/153.1

(57) ABSTRACT

A system and method of forming a mixture from two elements according to which the elements are introduced into a vessel and mixed in the vessel before being discharged from the vessel. The flow rate of one of the elements is controlled to maintain a constant level of the mixture in the vessel and the flow rate of the other element is controlled to maintain a predetermined ratio of the flow rate of the latter element and the discharge flow rate.

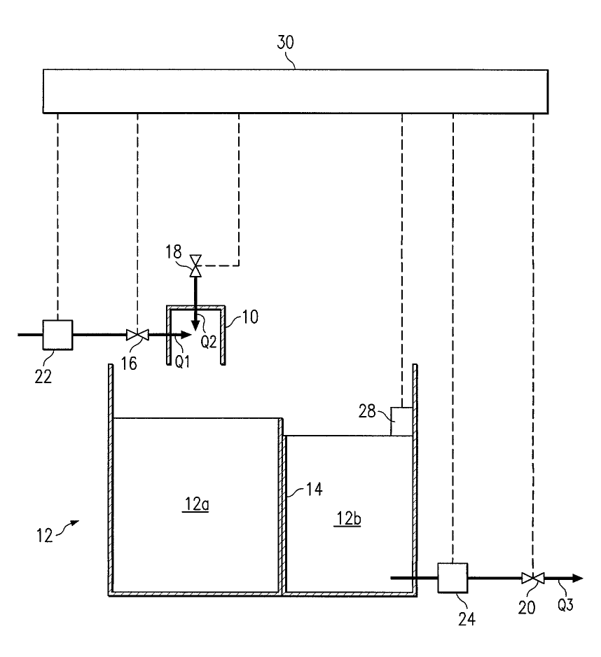

### BACKGROUND

In the drilling of oil and gas wells, a casing is usually placed in the well and cement, or some other similar material, is placed around the outside of the casing to protect the casing and prevent movement of formation fluids behind the casing. The cement is usually mixed in a mixer at the surface to form a slurry which is pumped down hole and around the outside of the casing. The mixing is typically done by mixing the cement ingredients, typically cement, water, chemicals, and other solids, until the proper slurry density is obtained, and then continuing to mix as much material as needed at that density while pumping the slurry down hole in a continuous process. Density is of primary importance because the resulting hydrostatic pressure of the slurry must be high enough to keep pressurized formation fluids in place but not so high as to fracture a weak formation.

Some wells require lightweight slurries that will not create enough hydrostatic pressure to fracture a weak formation. One way of creating light-weight slurries is to use low specific gravity solids in the blend. The problem with such slurries is that below certain densities, the ratio of solids to water can change significantly with only minor changes in density. Changes in solids-to-water ratio can affect slurry viscosity, compressive strength, and other properties. In these situations, density-based control systems do not work well.

Therefore, what is needed is a system and method for creating a relatively lightweight slurry that overcomes the above problems.

### BRIEF DESCRIPTION OF THE DRAWING

The drawing is a schematic diagram depicting the system of the present invention.

### DETAILED DESCRIPTION

Referring to the drawing, the reference numeral 10 refers to a mixing head which receives a quantity of water from an external source at a continuous volumetric rate Q1. The mixing head 10 communicates with a mixing vessel 12 for discharging the water into the mixing vessel 12. A partition 14 is provided in the mixing vessel 12 to define a first vessel portion 12a which receives the water from the mixing head 10, and a second vessel portion 12b. The height of the partition 14 is such that the water flows, by gravity, from the first vessel portion 12a to the second vessel portion 12b.

A quantity of cement solids, also from an external source, is introduced into the mixing head 10 at a continuous volumetric rate Q2. The water and the cement solids mix in the first vessel portion 12a to form a mixture, also referred to herein as a slurry, which flows into the second vessel portion 12b and which is discharged from an outlet in the second vessel portion 12b at a continuous volumetric rate Q3.

Three flow valves 16, 18, and 20 operate in a conventional manner to control the water flow rate Q1, the cement solids flow rate Q2, and the slurry flow rate Q3, respectively, and thus control the ratio Q1/Q3 so that it attains a predetermined value based on the flow rates Q1, Q2, and Q3. It is understood that actuators, or the like (not shown), may be associated with the flow valves 16, 18, and 20 to control, in a conventional manner, the positions of the flow valves 16, 18, and 20, and therefore the flow rates Q1, Q2, and Q3.

Two flow meters 22 and 24 are disposed upstream of the flow valves 16 and 20, and measure the flow rates Q1 and Q3, respectively. The flow meters 22 and 24 are conventional and could be in the form of turbine, magnetic, or coriolis meters. Although shown schematically for the convenience of presentation, it is understood that the flow valves 16, 18, and 20 and the flow meters 22 and 24 are connected in flow lines, in the form of conduits, pipes, etc. through which the water, the cement solids, and the slurry flow.

A measuring device 28 is provided in the second vessel portion 12b for measuring the slurry level. The measuring device 28 could be one of several conventional devices that are available for measuring liquid level including, but not limited to, radar, laser, ultrasonic, or float devices.

The process is controlled through a control unit 30 that includes a microprocessor, or the like, and is electrically connected to the flow valves 16, 18, and 20, the flow meters 22 and 24, and the measuring device 28. Since the control unit 30 can be one of a number of conventional devices, it will not be described in great detail. The control unit 30 receives signals from the flow meters 22 and 24 and the measuring device 28, processes the signals, and sends signals to the flow valves 16 and 20 to control same in a manner to be described. In this context, it is understood that a hydraulic control valve and an actuator can be associated with each flow valve 16, 18, and 20 to operate same and, since these units are conventional, they are not shown and will not be described in detail.

In operation, water is introduced at a flow rate Q1 into the mixing head 10 while cement solids are introduced at a flow rate Q2. The water and the cement solids pass from the mixing head 10 into the first vessel portion 12a where they mix to form a slurry which flows, by gravity, into the second vessel portion 12b and discharges therefrom at a flow rate Q3. The flow meters 22 and 24 meter the flow rates Q1 and Q3, respectively, and the measuring device 28 measures the slurry level in the second vessel portion 12b. Signals from the flow meters 22 and 24 corresponding to the flow rates Q1 and Q3, and signals from the measuring device 28 corresponding to the slurry level in the second vessel portion 12b are passed to, and processed in, the control unit 30. The control unit 30 monitors the signals and sends corresponding signals to the flow valves 16, 18, and 20 to control the flow through the flow valves 16, 18, and 20, and therefore the flow rates Q1, Q2, and Q3, accordingly.

The introduction of the cement solids into the first vessel portion 12a at the flow rate Q2 is controlled by the flow valve 18 to maintain a constant liquid level in the second vessel portion 12b, and the Q1/Q3 ratio is controlled by controlling the water flow rate Q1 by the flow valve 16 and the slurry flow rate Q3 by the flow valve 24. At steady-state conditions, this will yield the correct proportion of water and cement slurry based on the equation Q1+Q2=Q3.

In the event partial automatic control is desired, the flow rates Q1 and Q3 could be measured by the flow meters 22 and 24, respectively, and the flow valves 16 and 20 controlled accordingly by the control unit 30 as described above, while the cement solids flow rate Q2, as well as the slurry level in the second vessel portion 12b could be controlled manually. Alternatively, slurry flow rate Q3 could be controlled manually while flow rates Q1 and Q2 are controlled automatically by the control unit 30. Other combinations of partial and manual control are possible.

If it is desired to control the entire process manually, water flow rate Q1 and slurry flow rate Q3 would be measured and observed by an operator, preferably on a numeric display, along with the ratio Q1/Q3. The operator would set the flow rates to maintain the proper ratio and mixing rate and would also observe the slurry level in the second vessel portion 12b and add the cement solids by manually adjusting the flow valve 18 in order to keep the level constant.

It is understood that variations may be made in the foregoing without departing from the scope of the invention. For example, the elements forming the slurry can be varied within the scope of the invention and do not have to include cement. Also, the elements may be such that the slurry density becomes insensitive to changes in the solids-to-water ratio (Q2/Q1), a situation that will occur when the specific gravity (or density) of the slurry and the specific gravity (or density) of the one or more of the elements forming the slurry become sufficiently close in value. Besides lightweight slurries described above, this would also include high-density cement slurries such as those above 20 pounds per gallon.

Although only one exemplary embodiment of this invention has been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims.

What is claimed is:

1. A method of forming a mixture from two elements at least one of which is a liquid, comprising the steps of:
introducing a first element into a vessel at a flow rate;
introducing a second element into the vessel at a flow rate, causing the two elements to mix and form a mixture in the vessel;
discharging the mixture from the vessel;
controlling the flow rate of one of the two elements to maintain a constant level of the mixture in the vessel; and
controlling the flow rate of the other of the two elements to maintain a predetermined ratio of the flow rate of the latter element and the flow rate of the mixture discharged from the vessel.

2. The method of claim 1 wherein one of the two elements is water.

3. The method of claim 2 wherein the other element is cement.

4. The method of claim 1 further comprising the step of metering the flow of the two elements into the vessel and the mixture discharged from the vessel using meters.

5. The method of claim 4 further comprising the step of measuring the level of the mixture in the vessel.

6. The method of claim 5 wherein the step of controlling comprises:
providing valves in the flow path of the two elements and the mixture discharged from the vessel; and
controlling the opening of the valves.

7. The method of claim 6 wherein the step of controlling comprises connecting a control unit to the meters for controlling the opening of the valves in response to the metering and the measuring.

8. A system of forming a mixture from two elements at least one of which is a liquid, comprising:
a vessel into which the two elements are introduced and mixed to form a mixture, the vessel having an outlet for discharging the mixture from the vessel;
a valve for controlling the flow rate of one of the two elements to maintain a constant level of the mixture in the vessel; and
a valve for controlling the flow rate of the other of the two element to maintain a predetermined ratio of the flow rate of the latter element and the flow rate of the mixture discharged from the vessel.

9. The system of claim 8 further comprising at least one meter for metering the flow of the two elements into the vessel and the mixture discharged from the vessel.

10. The system of claim 9 further comprising a device for measuring the level of the mixture in the vessel.

11. The system of claim 10 further comprising a control unit connected to the at least one meter, the device, and the valves for controlling the opening of the valves, and therefore the flow rates of the two elements and the mixture discharged from the vessel, in response to the metering and the measuring.

12. A system of forming a mixture from two elements at least one of which is a liquid, comprising:
a mixing head for receiving a first element at a flow rate and a second element at a flow rate;
a vessel into which the two elements are discharged from the mixing head and mixed to form a mixture, the vessel having an outlet for discharging the mixture from the vessel at a flow rate;
valve means for controlling the flow rates of the two elements and the mixture discharged from the vessel;
flow meter means for metering the flow rates of the first element and the mixture discharged from the vessel;
level detector means for measuring the level of the mixture in the vessel; and
control means connected to the valve means, the flow meter means, and the level detector means;
wherein the control means receives signals from the flow meter means and the level detector means, and in response thereto, sends signals to the valve means to control the flow rate of the second element to maintain a constant level of the mixture in the vessel, and to control the flow rates of the first element and the discharged mixture to maintain a predetermined ratio thereof.

13. The system of claim 12 wherein the vessel comprises:
a first portion;
a second portion; and
a partition separating the first portion from the second portion;
wherein the two elements are discharged from the mixing head into the first portion, wherein the two elements are mixed to form the mixture in the first portion, wherein the mixture flows by gravity from the first portion into the second portion, and wherein the mixture is discharged from the outlet located in the second portion.

14. The system of claim 13 wherein the first element is water and the second element is cement.

15. The system of claim 14 wherein the valve means controls the flow rate of the cement to maintain a constant level of the mixture in the second portion.

16. A system of forming a mixture from two elements at least one of which is a liquid, comprising:
a mixing head for receiving a first element at a flow rate and a second element at a flow rate;
a vessel into which the two elements are discharged from the mixing head and mixed to form a mixture, the vessel having an outlet for discharging the mixture from the vessel at a flow rate;
a plurality of valves for controlling the flow rates of the two elements and the mixture discharged from the vessel;
a plurality of flow meters for metering the flow rates of the first element and the mixture discharged from the vessel;
a level detector for measuring the level of the mixture in the vessel; and
a control unit connected to the valves, the flow meters, and the level detector;
wherein the control unit receives signals from the flow meters and the level detector, and in response thereto, sends signals to the valves to control the flow rate of the second element to maintain a constant level of the mixture in the vessel, and to control the flow rates of the first element and the discharged mixture to maintain a predetermined ratio thereof.

17. The system of claim 16 wherein the vessel comprises:
a first portion;
a second portion; and
a partition separating the first portion from the second portion;
wherein the two elements are discharged from the mixing head into the first portion, wherein the two elements are mixed to form the mixture in the first portion, wherein the mixture flows by gravity from the first portion into the second portion, and wherein the mixture is discharged from the outlet located in the second portion.

18. The system of claim 17 wherein the first element is water and the second element is cement.

19. The system of claim 18 wherein one of the valves controls the flow rate of the cement to maintain a constant level of the mixture in the second portion.
